(19) United States
(12) Patent Application Publication
(10) Pub. No.: US 2025/0190651 A1
(43) Pub. Date: Jun. 12, 2025

(54) QUENCHING-ATTITUDE-SETTING PROGRAM, QUENCHING-ATTITUDE-SETTING METHOD, AND QUENCHING-ATTITUDE-SETTING DEVICE

(71) Applicant: NSK Ltd., Shinagawa-ku, Tokyo (JP)

(72) Inventors: Nobuyuki HAGIWARA, Takasaki-shi, Gunma (JP); Naoto KEMMOCHI, Takasaki-shi, Gunma (JP); Kouichi YAMAMOTO, Takasaki-shi, Gunma (JP)

(21) Appl. No.: 18/848,907

(22) PCT Filed: Nov. 30, 2022
(86) PCT No.: PCT/JP2022/044256

§ 371 Date: Sep. 20, 2024

(30) Foreign Application Priority Data
Mar. 24, 2022 (JP) 2022-048696

(51) Int. Cl. G06F 30/20; C21D 1/63; G06F 111/10

(52) U.S. Cl. CPC G06F 30/20; C21D 1/63; G06F 2111/10

(57) ABSTRACT

A quenching-attitude-setting program causes a computer to execute setting of the quenching attitude of an object to be quenched. The quenching-attitude-setting program causes the computer to execute a first process of dividing a virtual model obtained by modeling the object to be quenched into a plurality of elements based on a world coordinate system including a vertical direction as an axis, and a second process of evaluating whether a vapor film generated when the virtual model is immersed in cooling oil remains for each of the plurality of elements. In the quenching-attitude-setting program, the first process and the second process are repeated while changing an attitude of the virtual model with respect to the world coordinate system until the number of elements evaluated as having the vapor film remaining satisfies a preset condition.

### TECHNICAL FIELD

The present disclosure relates to a quenching-attitude-setting program, a quenching-attitude-setting method, and a quenching-attitude-setting device.

### BACKGROUND ART

Patent Literature 1 discloses a technique related to quenching of metal parts. In a quenching method disclosed in Patent Literature 1, an object to be quenched is immersed in a quenching agent from a feeder. The quenching method disclosed in Patent Literature 1 focuses on the attitude of an object to be quenched when the object to be quenched is immersed in the quenching agent from the feeder. When objects to be quenched are immersed in the quenching agent from the feeder, interference due to contact between the objects to be quenched or the like will influence the quenching results. In the quenching method disclosed in Patent Literature 1, a plurality of objects to be quenched are transported in a state where they do not come into contact with each other. As a result, contact between the objects to be quenched that occurs during immersion is avoided.

### CITATION LIST

### Patent Literature

[Patent Literature 1] Japanese Unexamined Patent Publication No. 2009-84635

### SUMMARY OF INVENTION

### Technical Problem

When a heated object to be quenched is immersed in liquid cooling oil, a so-called vapor film is generated on the surface of the object to be quenched. The vapor film on the surface of the object to be quenched prevents heat from transferring from the object to be quenched to the cooling oil. Variations in the state of the vapor film on the surface of the object to be quenched will give rise to variations in the degree of cooling of the object to be quenched. As a result, slight deformation of the object to be quenched may occur.

The present disclosure describes a quenching-attitude-setting program, a quenching-attitude-setting method, and a quenching-attitude-setting device that make it possible to provide an attitude of an object to be quenched capable of suppressing the influence of a vapor film on the result of quenching.

### Solution to Problem

According to an aspect of the present disclosure, there is provided a quenching-attitude-setting program for causing a computer to execute setting of a quenching attitude of an object to be quenched including a disc-shaped portion provided with a through hole. The quenching-attitude-setting program causes the computer to execute a first process of dividing a virtual model obtained by modeling the object to be quenched into a plurality of elements based on a coordinate system including a vertical direction as an axis, and a second process of evaluating whether a vapor film generated when the virtual model is immersed in a cooling liquid remains for each of the plurality of elements. In the quenching-attitude-setting program, the first process and the second process are repeated while changing an attitude of the virtual model with respect to the coordinate system until the number of elements evaluated as having the vapor film remaining satisfies a preset condition.

The above quenching-attitude-setting program obtains a plurality of elements that can be used to determine whether the vapor film remains through the first process. Next, it is determined whether the vapor film remains for each element through the second process. By repeating the first process and the second process while changing the attitude of the virtual model with respect to the coordinate system, an attitude in which the number of elements where the vapor film remains satisfies a desired condition is searched for. Therefore, the quenching-attitude-setting program makes it possible to provide an attitude of the object to be quenched capable of suppressing the influence of the vapor film on the result of quenching.

The first process of the above quenching-attitude-setting program may include dividing the virtual model into the elements each of which is a surface. The second process may include obtaining a function of a quadratic form that approximates the elements. The first process and the second process can make it easy to obtain an attitude of the object to be quenched capable of suppressing the influence of the vapor film on the result of quenching.

The second process of the above quenching-attitude-setting program may include evaluating a tilt of the element using the function. This second process can also make it easy to obtain an attitude of the object to be quenched capable of suppressing the influence of the vapor film on the result of quenching.

Evaluating the tilt of the element of the above quenching-attitude-setting program may include evaluating whether there are extreme values in the function by partially differentiating the function. This process can make it easy to determine whether there is a possibility that the vapor film will remain.

The second process of the above quenching-attitude-setting program may include specifying either a main surface or a rear surface included in the element which is in contact with the cooling liquid. This second process can make it easy to determine elements on which no vapor film remains.

The second process of the above quenching-attitude-setting program may include identifying which of a plurality of quadratic surfaces prepared in advance the shape of the element corresponds to by using the function. This second process can also make it easy to determine whether there is a possibility that the vapor film will remain.

Identifying which of the plurality of quadratic surfaces of the above quenching-attitude-setting program the shape corresponds to may include obtaining a decision determinant through second-order partial differentiation of the function, and evaluating which of defining equations that define the plurality of quadratic surfaces the decision determinant corresponds to. This process can make it easy to identify the type of surface.

According to another aspect of the present disclosure, there is provided a quenching-attitude-setting method of setting a quenching attitude of an object to be quenched including a disc-shaped portion provided with a through hole. The quenching-attitude-setting method includes executing a first process of dividing a virtual model obtained by modeling the object to be quenched into a plurality of elements based on a coordinate system including a vertical direction as an axis, and executing a second process of evaluating whether a vapor film generated when the virtual model is immersed in a cooling liquid remains for each of the plurality of elements. In the quenching-attitude-setting method, the first process and the second process are repeated while changing an attitude of the virtual model with respect to the coordinate system until the number of elements evaluated as having the vapor film remaining satisfies a preset condition.

The quenching-attitude-setting method makes it possible to provide an attitude of the object to be quenched capable of suppressing the influence of the vapor film on the result of quenching.

According to still another aspect of the present disclosure, there is provided a quenching-attitude-setting device configured to set a quenching attitude of an object to be quenched including a disc-shaped portion provided with a through hole. The quenching-attitude-setting device includes a first processing unit configured to execute a first process of dividing a virtual model obtained by modeling the object to be quenched into a plurality of elements based on a coordinate system including a vertical direction as an axis, and a second processing unit configured to execute a second process of evaluating whether a vapor film generated when the virtual model is immersed in a cooling liquid remains for each of the plurality of elements. In the quenching-attitude-setting device, an operation of the first processing unit and an operation of the second processing unit are repeated while changing an attitude of the virtual model with respect to the coordinate system until the number of elements evaluated as having the vapor film remaining satisfies a preset condition.

The quenching-attitude-setting device also makes it possible to provide an attitude of the object to be quenched capable of suppressing the influence of the vapor film on the result of quenching.

### Advantageous Effects of Invention

The quenching-attitude-setting program, the quenching-attitude-setting method, and the quenching-attitude-setting device of the present disclosure make it possible to provide an attitude of the object to be quenched capable of suppressing the influence of the vapor film on the result of quenching.

### BRIEF DESCRIPTION OF DRAWINGS

FIG. 1 is a schematic diagram illustrating quenching facilities.

FIG. 2 is a side view of an object to be quenched which is disposed in a quenching tool.

FIG. 3 is a side view illustrating a relationship between a non-tilted object to be quenched and a vapor film.

FIG. 4 is another side view illustrating a relationship between a non-tilted object to be quenched and a vapor film.

FIG. 5 is a flow diagram illustrating main steps of a quenching-attitude-setting method.

FIG. 6 is a flow diagram illustrating steps shown in FIG. 5 in more detail.

FIG. 7 is a flow diagram illustrating steps shown in FIG. 5 following FIG. 6 in more detail.

FIG. 8 is a diagram illustrating a procedure of setting a node function.

FIGS. 9(a), 9(b), 9(c), 9(d), 9(e), and 9(f) are examples of surfaces which are approximated by node functions.

FIG. 10 is a diagram illustrating physical components of a quenching-attitude-setting device.

FIG. 11 is a functional block diagram of the quenching-attitude-setting device.

FIG. 12(a) is a diagram illustrating a modification example for obtaining the attitude of an object to be quenched including one jig, and FIG. 12(b) is a diagram illustrating a modification example for obtaining the attitude of an object to be quenched including two jigs.

FIG. 13(a) is a diagram illustrating the attitude of an object to be quenched used in examination example 1, FIG. 13(b) is a diagram illustrating the attitude of an object to be quenched used in examination example 2, and FIG. 13(c) is a diagram illustrating the attitude of an object to be quenched used in examination example 3.

FIG. 14(a) is a diagram illustrating the attitude of an object to be quenched used in examination example 4, and FIG. 14(b) is a diagram illustrating the attitude of an object to be quenched used in examination example 5.

FIG. 15(a) is a diagram illustrating the attitude of an object to be quenched used in examination example 6, and FIG. 15(b) is a diagram illustrating an enlarged view of a portion of FIG. 15(a).

FIG. 16(a) is a diagram illustrating the attitude of an object to be quenched used in examination example 7, and FIG. 16(b) is a diagram illustrating an enlarged view of a portion of FIG. 16(a).

### DESCRIPTION OF EMBODIMENTS

Hereinafter, a quenching tool and a quenching method of the present disclosure will be described in detail with reference to the accompanying drawings. Meanwhile, in the description of the drawings, the same elements are denoted by the same reference numerals and signs, and thus description thereof will not be repeated.

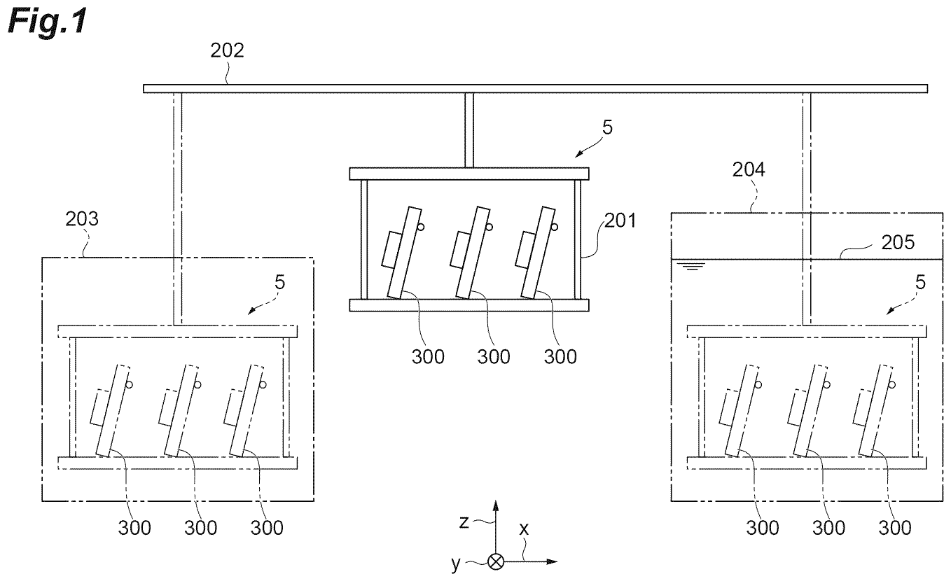

FIG. 1 is a diagram illustrating a schematic diagram illustrating quenching facilities to which a quenching tool 5 is applied. An object 300 to be quenched is a bearing part. For example, the object 300 to be quenched is used for a needle thrust bearing, a needle shell bearing, a thin-walled bearing, a large-diameter bearing, and the like.

As shown in FIG. 1, the quenching tool 5 is suspended by a suspension cable 201 or the like. The suspension cable 201 is connected to a movement mechanism 202. The movement mechanism 202 moves the quenching tool 5 from a heating furnace 203 to a cooling tank 204.

The quenching tool 5 holds a plurality of objects 300 to be quenched. The quenching tool 5 holds the objects 300 to be quenched at a tilt when the objects 300 to be quenched are immersed in cooling oil 205. In the following description, the terms “tilt” and “tilted” mean that the object axis A of the object 300 to be quenched is not parallel to the horizontal direction (axis x). The phrase “not parallel” does not include “perpendicular.” That is, “tilt” and “tilted” mean that the angle between the object axis A and the horizontal direction (axis x) is greater than 0 degrees and less than 90 degrees.

### [Object to be Quenched]

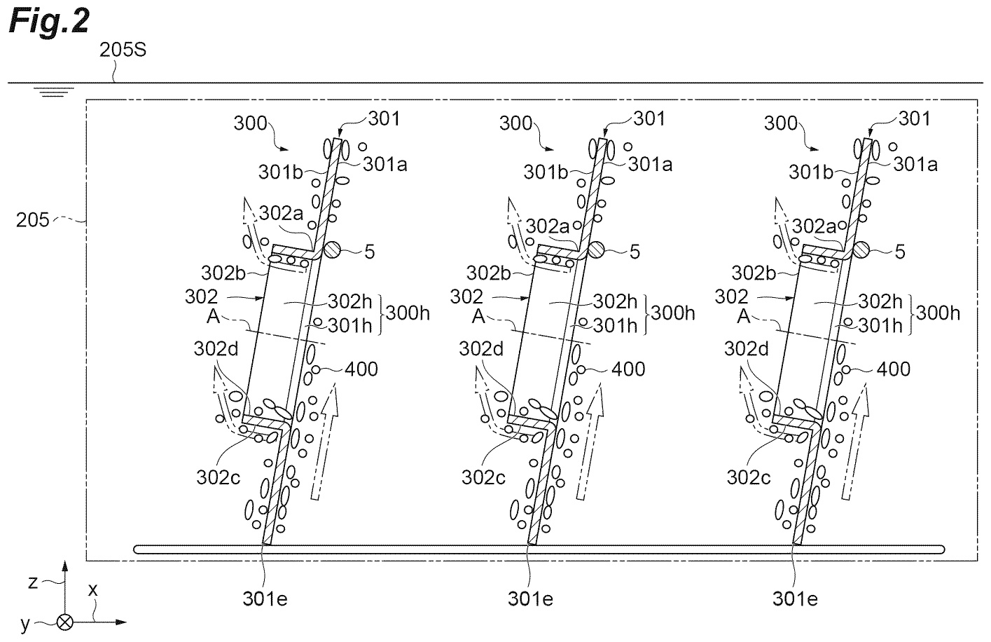

As shown in FIG. 2, the object 300 to be quenched has a disc-like race 301 and a cylindrical lip 302. The shape of the object 300 to be quenched is not limited to that shown in FIG. 2. Some other shapes of the object 300 to be quenched will be exemplified in the section of modification examples to be described later.

The race 301 is a thin plate having a thickness smaller than the outer diameter. When the object 300 to be quenched is immersed in the cooling oil 205 (cooling liquid), the surface of the object 300 to be quenched which is in contact with the cooling oil 205 is rapidly cooled. The heat inside the object 300 to be quenched transfers gradually to the surface of the object 300 to be quenched. Strictly speaking, there is a difference in the state of cooling between the surface side and the interior side of the object 300 to be quenched. However, the thickness of the object 300 to be quenched which is exemplified in the present disclosure is thin. Therefore, the object 300 to be quenched can be considered to have substantially no difference in the mode of cooling between the surface and the interior. That is, the term “thin plate” in the present embodiment refers to a plate that can be considered to have substantially no difference in the mode of cooling between the surface and the interior during cooling.

The race 301 has a race main surface 301a, a race rear surface 301b, and a race through hole 301h. The race main surface 301a is a flat surface with no substantial irregularities. The lip 302 is provided on the race rear surface 301b. The lip 302 extends from the race rear surface 301b in a direction normal to the race rear surface 301b. The race 301 and the lip 302 are press-molded from a single plate material. Therefore, there is no physical boundary that separates the race 301 and the lip 302.

The central axis of the lip 302 coincides with the central axis of the race 301. The lip 302 is coaxial with the race 301. The lip 302 has a lip base end 302a, a lip tip 302b, and a lip through hole 302h. The lip base end 302a is connected to the race rear surface 301b. The lip tip 302b is a free end. The height of the lip 302 may be less than the outer diameter of the lip 302. The lip through hole 302h forms an object through hole 300h together with the race through hole 301h. The inner diameter of the lip through hole 302h is the same as the inner diameter of the race through hole 301h.

The results of quenching can be evaluated, for example, by the warpage of the race 301 and the roundness of the lip 302. When the state of quenching is non-uniform, the warpage of the race 301 may occur. When the state of quenching is non-uniform, the roundness of the lip 302 may decrease.

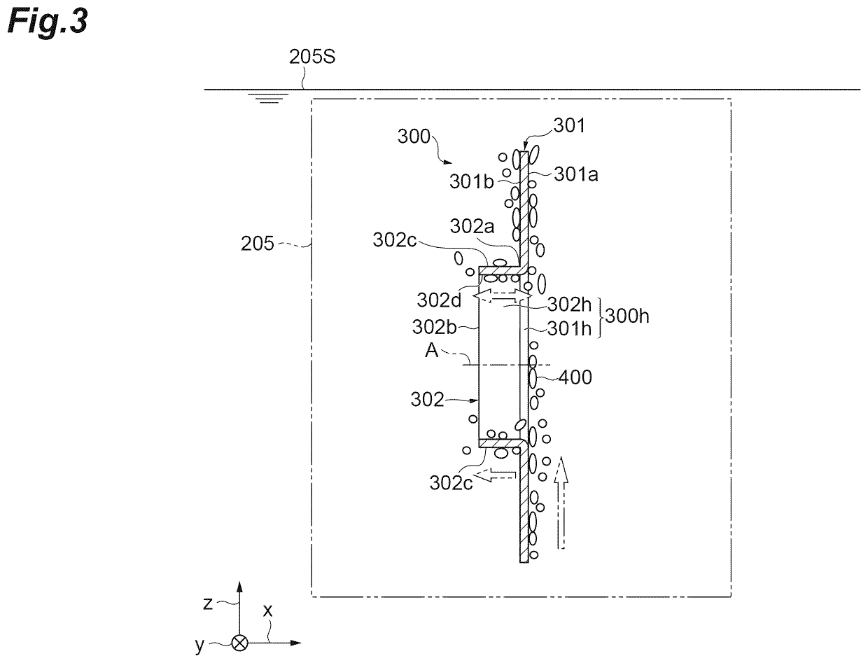

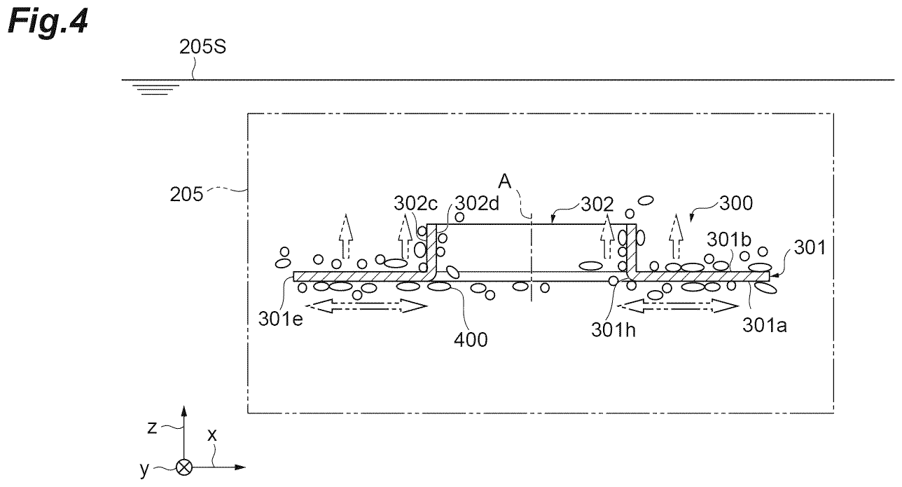

Referring to FIGS. 3 and 4, a phenomenon that occurs in a case where the object 300 to be quenched is disposed without being tilted will be examined. The purpose of the quenching tool 5 holding the object 300 to be quenched at a tilt is to reduce the number of locations where a vapor film is likely to remain. The vapor film is a film of gas which is generated on the surface of the object 300 to be quenched when the heated object 300 to be quenched is immersed in the cooling oil 205. When a vapor film is formed on the surface of the object 300 to be quenched, the surface of the object 300 to be quenched is not in direct contact with the cooling oil 205. The ease of heat transfer differs between the vapor film and the cooling oil. When a region which is in contact with the vapor film for a long period of time and a region which is in contact with the vapor film for a short period of time are mixed on the surface of the object 300 to be quenched, the state of quenching will be uneven. The unevenness in the state of quenching influences the warpage of the race 301 and the roundness of the lip 302.

For example, as shown in FIG. 3, it is assumed that the object axis A of the object 300 to be quenched is parallel to the horizontal direction (axis x) when the object 300 to be quenched is immersed in the cooling oil 205. The attitude of the object 300 to be quenched shown in FIG. 3 is not tilted.

It is assumed that a vapor film 400 is generated on the surface of the race 301 in the state shown in FIG. 3. The vapor film 400 which is a gas moves toward an oil surface 205S. In a case where the vapor film 400 moves along the race main surface 301a and the race rear surface 301b, there are no elements that prevent the vapor film 400 from moving from the race main surface 301a and the race rear surface 301b toward the oil surface 205S. Therefore, the race main surface 301a and the race rear surface 301b are regions that are in contact with the vapor film 400 for a short period of time.

Next, it is assumed that the vapor film 400 is generated on the surface of the lip 302. The surface of the lip 302 includes a lip outer circumferential surface 302c and a lip inner circumferential surface 302d. The vapor film 400 generated on the lip outer circumferential surface 302c can quickly move along the lip outer circumferential surface 302c toward the oil surface 205S. This is because there are no elements that prevent the vapor film 400 from moving the lip outer circumferential surface 302c toward the oil surface 205S. Therefore, the lip outer circumferential surface 302c is a region which is in contact with the vapor film 400 for a short period of time.

On the other hand, a portion of the vapor film 400 generated on the lip inner circumferential surface 302d cannot move quickly from the lip inner circumferential surface 302d toward the oil surface 205S. Specifically, in a region above the lip inner circumferential surface 302d, the lip inner circumferential surface 302d exists between the vapor film 400 and the oil surface 205S. This state can also be expressed, for example, as the vapor film 400 being blocked by the lip inner circumferential surface 302d. Therefore, the vapor film 400 cannot move toward the oil surface 205S unless it moves in the horizontal direction (axis x) rather than in the vertical direction (axis z). In a case where this movement in the horizontal direction (axis x) is involved, the time of contact with the vapor film 400 tends to be longer than in a case where movement only in the horizontal direction (axis x) is not involved. That is, the lip inner circumferential surface 302d is a region which is in contact with the vapor film 400 for a long period of time. According to the attitude of the object 300 to be quenched shown in FIG. 3, there is a possibility of the roundness of the lip 302 being influenced.

It can be understood that in order to shorten the contact time of the vapor film 400, it is necessary to avoid a state in which the vapor film 400 is blocked. Consequently, the object 300 to be quenched is tilted using the quenching tool 5. As shown in FIG. 2, when the object 300 to be quenched is tilted, the lip tip 302b is located above the lip base end 302a. In that case, the lip inner circumferential surface 302d is tilted along the object axis A. This tilt allows the vapor film 400 to move to the oil surface 205S while moving in an oblique upward direction. That is, the vapor film 400 can move from the lip inner circumferential surface 302d toward the oil surface 205S without involving movement only in the horizontal direction (axis x). As a result, the lip inner circumferential surface 302d serves as a region which is in contact with the vapor film 400 for a short period of time.

FIG. 4 is another example in which the object 300 to be quenched is assumed to be not tilted. As shown in FIG. 4, it is assumed that the object axis A of the object 300 to be quenched is parallel to the vertical direction (axis z). According to this attitude, the race main surface 301a extends in the horizontal direction (axis x). The vapor film 400 generated on the race main surface 301a moves along the race main surface 301a. That is, the vapor film 400 generated on the race main surface 301a moves in the horizontal direction (axis x) and then moves from a race outer circumferential edge 301e toward the oil surface 205S. Therefore, the race main surface 301a is a region which is in contact with the vapor film 400 for a long period of time. There is a possibility of the attitude of the object 300 to be quenched as shown in FIG. 4 influencing the warpage of the race 301.

A quenching-attitude-setting program, a quenching-attitude-setting method, and a quenching-attitude-setting device of the present disclosure assist in determining the attitude of the object 300 to be quenched which is capable of suppressing the influence of the vapor film on the result of quenching.

### [Quenching-Attitude-Setting Program, Quenching-Attitude-Setting Method]

A quenching-attitude-setting method executed by a quenching-attitude-setting program will be described.

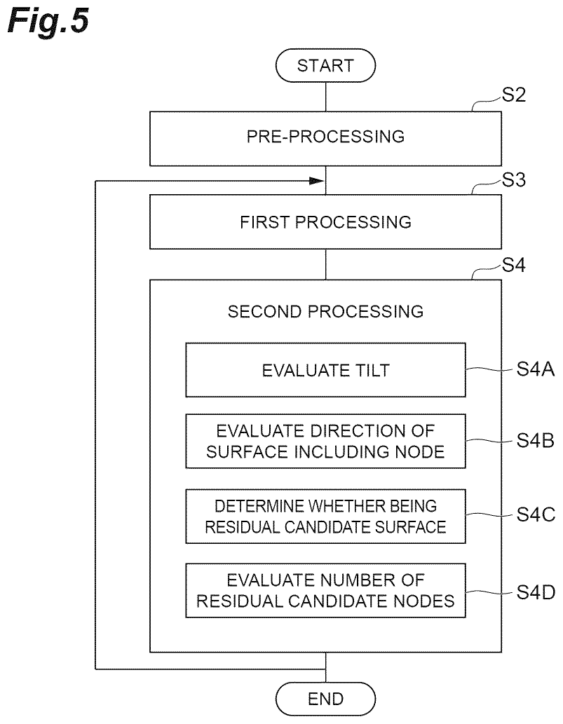

FIG. 5 is a flow diagram illustrating main steps of a quenching-attitude-setting method. The quenching-attitude-setting method includes a pre-processing step S2, a first processing step S3, and a second processing step S4. The pre-processing step S2 executes a preliminary process for extracting residual candidate nodes. The first processing step S3 involves generating node information for extracting residual candidate nodes. The second processing step S4 involves identifying whether the type of node is a residual candidate node. The identification of whether the type of node is a residual candidate node is to automatically determine whether the vapor film 400 remains. Therefore, the identification of whether the type of node is a residual candidate node can also be referred to as “evaluation of a remaining vapor film.” The second processing step S4 involves using the number of residual candidate nodes to determine whether the attitude of a virtual model used for evaluation can be adopted as a quenching attitude. In a case where the attitude can be adopted as a quenching attitude, the attitude set in a virtual model is output as a quenching attitude. In a case where the attitude cannot be adopted as a quenching attitude, the attitude of the virtual model is changed and the first processing step S3 is executed again.

The second processing step S4 includes, as main steps, a step S4A of evaluating a tilt, a step S4B of evaluating the direction of the surface including a node NA, a step S4C of determining whether the type of surface is a residual candidate surface, and a step S4D of evaluating the number of residual candidate nodes. The second processing step S4 may include other steps which are executed in conjunction with the above steps.

### [Pre-Processing Step]

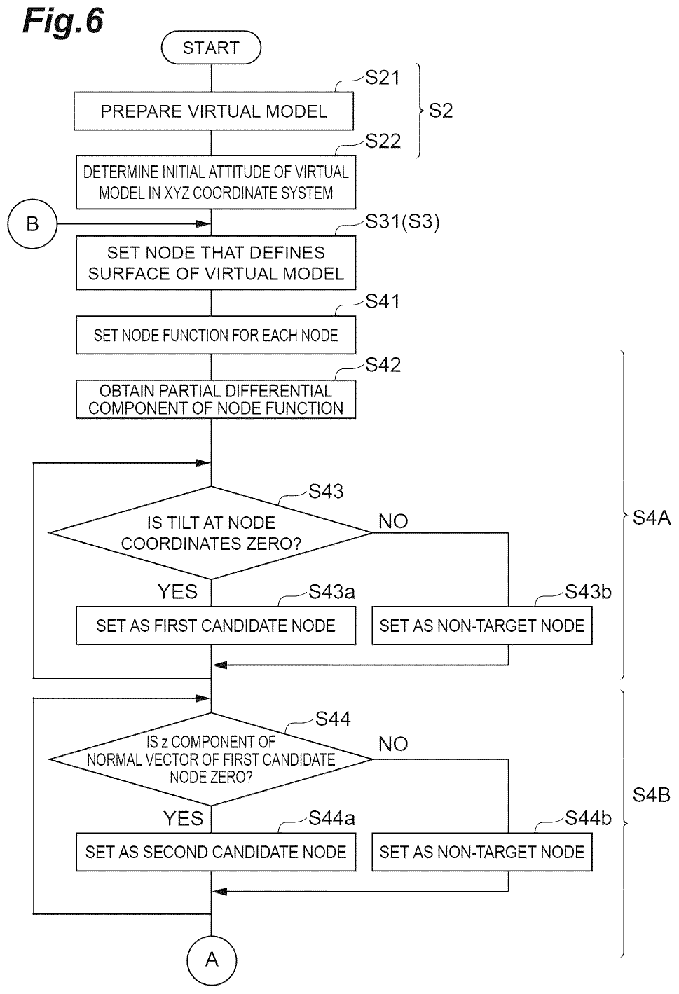

As shown in FIG. 6, virtual model information which is shape data of a virtual model is prepared (step S21). The virtual model information is, for example, output data of a three-dimensional CAD.

Next, the initial attitude of a virtual model is determined (step S22). The attitude of the virtual model is defined by an xyz coordinate system with the vertical direction as the z axis. The initial attitude may be, for example, an attitude in which the virtual axis of the virtual model is parallel to the x axis. That is, the attitude of the virtual model may be defined by, for example, the relationship between the virtual axis of the object through hole 300h and the coordinate axes.

### [First Processing Step]

The first processing step S3 involves dividing the virtual model into a plurality of elements (step S31). The term “element” referred to here is a portion of the surface of the virtual model. The portion of the surface of the virtual model is, for example, a curved surface. The portion of the surface of the virtual model is, for example, a flat surface. The portion of the surface of the virtual model has its position defined by the coordinates of the node NA.

First, nodes are set. The setting of the nodes includes a so-called meshing process of dividing the virtual model into a plurality of elements. A desired program may be used for the meshing of the virtual model. A plurality of meshes includes nodes which are virtual point elements. The virtual model has a predetermined thickness. Therefore, when meshing of the virtual model is executed, the virtual model is divided into a plurality of solid elements. As a result, for example, a node that defines the lip outer circumferential surface 302c and a node that indicates the lip inner circumferential surface 302d are set for the lip 302.

The node includes coordinate information. The coordinate information is not a local coordinate system which is set in the virtual model. The coordinate information is based on a world coordinate system CS which is set in the virtual space in which the virtual model is disposed. In a case where the coordinate information of the node complies with the local coordinate system, the coordinate information of the node is not influenced by the attitude of the virtual model. The local coordinate system is used to follow the attitude of the virtual model. In a case where the coordinate information of the node complies with the world coordinate system CS, the coordinate information of the node is influenced by the attitude of the virtual model. Since the quenching setting method involves setting the attitude of the object to be quenched, it is necessary to consider the influence of the attitude in the calculation. Therefore, the coordinate information of the node complies with the world coordinate system CS.

There are no particular limitations on the specific process of generating mesh information from virtual model information. For example, first, node information that complies with the local coordinate system is generated using the virtual model information. Next, using information on the attitude of the virtual model that complies with the world coordinate system CS, a coordinate conversion process may be performed on node information that complies with the local coordinate system to node information that complies with the world coordinate system CS.

### [Second Processing Step]

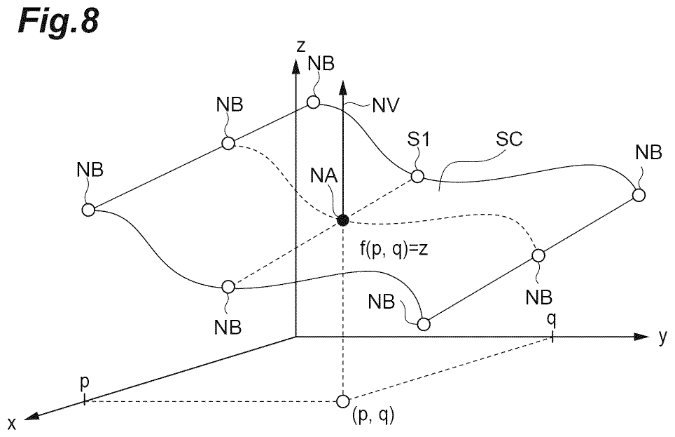

First, a node function f(x, y) is set for each node (step S41). As shown in FIG. 8, the node function f(x, y) defines a virtual three-dimensional curved surface SC with the node NA as a representative point. The node function f(x, y) may be, for example, a function of two variables with the variables x and y as independent variables and the variable z as a dependent variable. That is, the node function f(x, y) may be a function of the quadratic form shown in Equation (1).

$$\begin{matrix}[ Equation 1 ] & \\ ( x , y ) = ( p , q ) + ( X , Y ) ; = point ( on xy plane ) + amount of change & ( 1 )\end{matrix}$$

The node function f(x, y) is defined by the world coordinate system CS which is a three-dimensional coordinate system. The world coordinate system CS has an x axis, a y axis, and a z axis. The node function f(x, y) is a function (z=f(x, y)) that represents a general curved surface existing in the world coordinate system CS. The z axis is parallel to the gravity vector. The direction of the z axis is opposite to the direction of the gravity vector.

Now, a point indicated by the coordinates (p, q) is referred to as the node NA. The amount of change (X, Y) based on the coordinates (p, q) of the node NA is defined. The three-dimensional curved surface SC is approximated by a quadratic function. Specifically, the coordinates (x, y) of any point included in the three-dimensional curved surface SC can be expressed in the form of a quadratic form as shown in Equations (1) and (2) by using the coordinates (p, q) of the node NA and the amount of change (X, Y).

$$\begin{matrix}[ Equation 2 ] & \\ f ( x , y ) = f ( p , q ) + ( \tilde{r} ) f ( p , q ) / \partial x \partial f ( p , q ) / \partial y ) ( \begin{matrix}X \\ Y\end{matrix} ) + ( X , Y ) [ \begin{matrix}\frac{{\partial }^{2} f ( p , q )}{\partial x \partial x} & \frac{{\partial }^{2} f ( p , q )}{\partial x \partial y} \\ \frac{{\partial }^{2} f ( p , q )}{\partial y \partial x} & \frac{{\partial }^{2} f ( p , q )}{\partial y \partial y}\end{matrix} ] ( \begin{matrix}X \\ Y\end{matrix} ) & ( 2 )\end{matrix}$$

The partial differential components can be replaced as shown in Equation (3) and Equation (4), respectively. Equation (3) shows the tilt at the coordinates (p, q). Equation (4) is the determinant of the node function.

$$\begin{matrix}[ Equation 3 ] & \\ ( α , β ) = ( \frac{\partial f ( p , q )}{\partial x} \cdot \frac{\partial f ( p , q )}{\partial y} ) & ( 3 )\end{matrix}$$

$$\begin{matrix}[ Equation 4 ] & \\ [ \begin{matrix}a & b \\ b & c\end{matrix} ] = [ \begin{matrix}\frac{{\partial }^{2} f ( p , q )}{\partial x \partial x} & \frac{{\partial }^{2} f ( p , q )}{\partial x \partial y} \\ \frac{{\partial }^{2} f ( p , q )}{\partial y \partial x} & \frac{{\partial }^{2} f ( p , q )}{\partial y \partial y}\end{matrix} ] & ( 4 )\end{matrix}$$

Referring to FIG. 8, a procedure of obtaining the node function f(x, y) to be set at the node NA is illustrated. A predetermined region including the node NA as its center is set. Next, a node NB included in the predetermined region is extracted. A function that defines an approximate curved surface including the node NA and the node NB is obtained as the node function f(x, y) using coordinate information of the node NA and the node NB. Any calculation method may be used to obtain the approximation function from the coordinate information of node NA and a plurality of nodes NB.

The node function f(x, y) may be set for all nodes set in the virtual model. In addition, the node function f(x, y) may be set for some nodes extracted in accordance with a predetermined rule. As a result of executing step S31, a plurality of node functions f(x, y) which are set for each of the plurality of nodes are obtained.

Next, the tilt is evaluated (step S4A). As described in the explanation using FIGS. 3 and 4, the location where the vapor film 400 is likely to remain is a portion where the vapor film 400 cannot move toward the oil surface 205S unless it moves in the horizontal direction (axis x). That is, the location where the vapor film 400 is likely to remain includes a plane or a line orthogonal to the z axis. In short, when the surface including the node NA is not orthogonal to the z axis and is tilted, the vapor film 400 can move toward the oil surface 205S. However, in the vicinity of the extreme value, the vapor film 400 cannot move toward the oil surface 205S. The extreme value can be defined by Equation (5).

$$\begin{matrix}[ Equation 5 ] & \\ ( α , β ) = ( 0 , 0 ) & ( 5 )\end{matrix}$$

When orthogonality to the z axis is expressed using the node function f(x, y), the value obtained by substituting the coordinates (p, q) of the node NA into the differential component of the node function f(x, y) is zero.

Consequently, in step S4A, the tilt is evaluated using the partial differential components of the node function f(x, y). The node function f(x, y) is a quadratic form shown in Equation (1). Consequently, the node function f(x, y) is partially differentiated with respect to the variable x, and the node function f(x, y) is partially differentiated with respect to the variable y (step S42). As a result, as shown in Equation (3), a function indicating the tilt at the coordinates (x, y) is obtained. By substituting the coordinates (p, q) of the node NA to be evaluated into Equation (3), a numerical value indicating the tilt is obtained.

Next, whether the tilt at the coordinates (p, q) of the node NA is zero is evaluated using Equation (3) (step S43). The coordinates (p, q) of the node NA are substituted into the partial differential components obtained in step S42. As a result, a numerical value indicating the tilt is obtained. Next, whether the numerical value indicating the tilt is zero is evaluated. In a case where the numerical value indicating the tilt can be evaluated to be zero (step S43: YES), the node NA is set as a first candidate node as it is a location where the vapor film 400 is likely to remain (step S43a). That is, in a case where Equation (5) is satisfied, the node NA is set as the first candidate node.

For example, in the virtual model displayed on the display device, the first candidate node may be displayed in yellow. In a case where the numerical value indicating the tilt can be evaluated not to be zero (step S43: NO), the node NA is set as a non-target node as it is not a location where the vapor film 400 is likely to remain (step S43b). Meanwhile, the setting at the non-target node may be omitted. That is, step S43b may be omitted.

Meanwhile, in step S43, “tilt is zero” does not necessarily mean that the numerical value indicating the tilt is strictly zero. For example, a predetermined numerical value range (Δ) including zero is set. Even in a case where the numerical value indicating the tilt is included in the range of −Δ<0<+Δ, it may be evaluated as “tilt is zero.”

In step S43 of evaluating the tilt, all nodes for which the node function f(x, y) is set are targets for processing. Step S43 is repeatedly executed until the processing is completed for all nodes which are targets for processing.

Next, the direction of the curved surface including the first candidate node is evaluated (step S4B). For example, the curved surface including the first candidate node of which the tilt is zero includes two forms. The first form is that the direction of the surface including the first candidate node is vertically upward. The second form is that the direction of the surface including the first candidate node is vertically downward.

In the case of the first form, the cooling oil 205 exists in the upward direction of the surface including the first candidate node. In this form, the vapor film 400 can be separated from the virtual model without being impeded. On the other hand, in the case of the second form, the virtual model exists in the upward direction of the surface including the first candidate node. That is, the vapor film 400 described above is in the state of being blocked by the virtual model. In this state, the vapor film 400 cannot move toward the oil surface 205S. Consequently, among the first candidate nodes, those having the second form are extracted as second candidate nodes. This condition can be defined as, for example, that the vapor film 400 does not remain in the portion of the extreme value where the positive z direction from the point of the extreme value is not substantial.

The direction of the surface including the first candidate node may be determined using, for example, a normal vector NV (see FIG. 8) included in the node information (step S44). For example, in the meshing of step S31, the normal vector NV is set to face in a direction in which the entity of the virtual model does not exist. As a result, in a case where the z component of the normal vector NV is upward (positive) (step S44: NO), it can be determined to be the first form. As a result, it is set as a non-target node (step S44b). In a case where the z component of the normal vector NV is downward (negative) (step S44: YES), it can be determined to be the second form. As a result, it is set as the second candidate node (step S44a).

Meanwhile, the setting of the non-target node may be omitted. That is, step S43b may be omitted. In addition, a method of determining the direction of the surface including the first candidate node using the normal vector NV is an example. The direction of the curved surface including the first candidate node may be determined by another method.

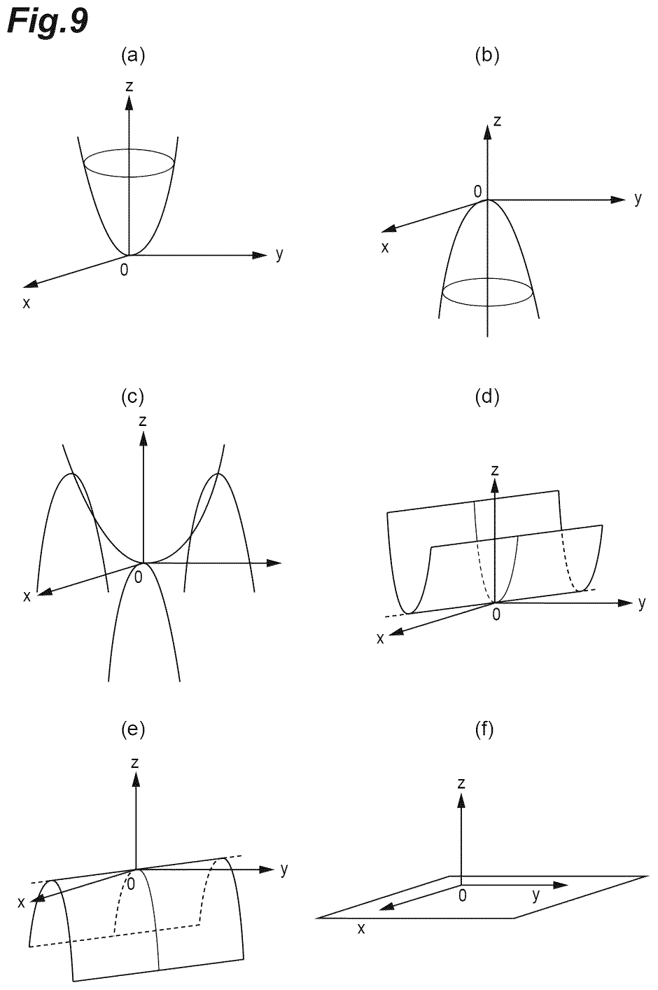

Next, it is determined whether the type of surface is a residual candidate surface (step S4C). The node function f(x, y) is set to be a function of the quadratic form. In this case, as shown in FIGS. 9(a) to 9(f), the surfaces including the node NA can be classified into six types. Each of the surfaces can be identified using the determinant shown in Equation (4). In FIGS. 9(a) to 9(f), the origin is the extreme value. The amount of change from the extreme value is shown as X, Y, and Z. When the node function f(x, y) in Equation (2) is an extreme value, the amount of change in Z can be defined as Z=z−f(p, q).

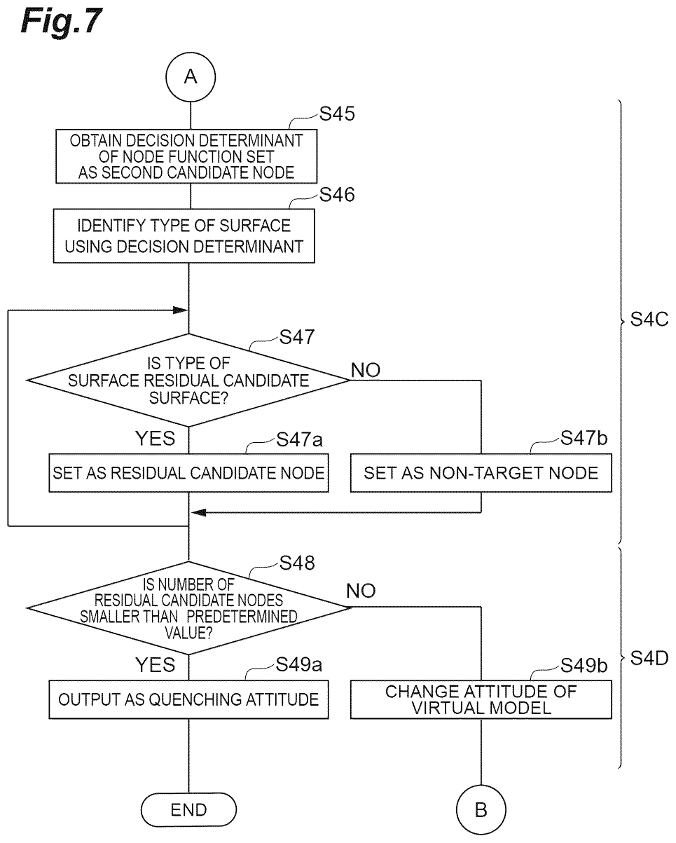

As shown in FIG. 7, a decision determinant is obtained using the node function f(x, y) of the second candidate node (step S45). The decision determinant is given by Equation (4).

Next, the type of surface is identified using the decision determinant (step S46). Specifically, the identification is based on whether the decision determinant corresponds to any of the defining equation defined for each type of surface.

FIG. 9(a) is an elliptical paraboloid which is convex downwardly. Equation (6) defines an elliptical paraboloid which is convex downwardly. When the determinant of the node function f(x, y) satisfies the condition shown in Equation (6), the surface including the node NA at which the node function f(x, y) is set can be identified as an elliptical paraboloid which is convex downwardly.

$$\begin{matrix}[ Equation 6 ] & \\ \begin{matrix}det [ \begin{matrix}a & b \\ b & c\end{matrix} ] > 0 & a > 0\end{matrix} & ( 6 )\end{matrix}$$

FIG. 9(b) is an elliptical paraboloid which is convex upwardly. Equation (7) defines an elliptical paraboloid which is convex upwardly. When the determinant of the node function f(x, y) satisfies the condition shown in Equation (7), the surface including the node NA at which the node function f(x, y) is set can be identified as an elliptical paraboloid which is convex upwardly.

$$\begin{matrix}[ Equation 7 ] & \\ \begin{matrix}det [ \begin{matrix}a & b \\ b & c\end{matrix} ] > 0 & a < 0\end{matrix} & ( 7 )\end{matrix}$$

FIG. 9(c) is a hyperbolic paraboloid. Equation (8) defines a hyperbolic paraboloid. When the determinant of the node function f(x, y) satisfies the condition shown in Equation (8), the surface including the node NA at which the node function f(x, y) is set can be identified as a hyperbolic paraboloid.

$$\begin{matrix}[ Equation 8 ] & \\ det [ \begin{matrix}a & b \\ b & c\end{matrix} ] < 0 & ( 8 )\end{matrix}$$

FIG. 9(d) is a parabolic cylindrical surface which is convex downwardly. Equation (9) defines a parabolic cylindrical surface which is convex downwardly. When the determinant of the hyperbolic paraboloid node function f(x, y) satisfies the condition shown in Equation (9), the surface including the node NA at which the node function f(x, y) is set can be identified as a parabolic cylindrical surface which is convex downwardly.

$$\begin{matrix}[ Equation 9 ] & \\ \begin{matrix}det [ \begin{matrix}a & b \\ b & c\end{matrix} ] = 0 & a > 0\end{matrix} & ( 9 )\end{matrix}$$

FIG. 9(e) is a parabolic cylindrical surface which is convex upwardly. Equation (10) defines a parabolic cylindrical surface which is convex upwardly. When the determinant of the node function f(x, y) satisfies the condition shown in Equation (10), the surface including the node NA at which the node function f(x, y) is set can be identified as a parabolic cylindrical surface which is convex upwardly.

$$\begin{matrix}[ Equation 10 ] & \\ \begin{matrix}det [ \begin{matrix}a & b \\ b & c\end{matrix} ] = 0 & a < 0\end{matrix} & ( 10 )\end{matrix}$$

FIG. 9(f) is a plane. Equation (11) defines a plane. When the determinant of the node function f(x, y) satisfies the condition shown in Equation (11), the surface including the node NA at which the node function f(x, y) is set can be identified as a plane.

$$\begin{matrix}[ Equation 11 ] & \\ \begin{matrix}det [ \begin{matrix}a & b \\ b & c\end{matrix} ] = 0 & a = 0 , c = 0\end{matrix} & ( 11 )\end{matrix}$$

Next, it is determined whether the type of surface is a residual candidate surface (step S47). Among the surfaces shown in FIGS. 9(a) to 9(f), those on which the vapor film 400 is likely to remain are the surfaces shown in FIGS. 9(b), 9(e), and 9(f). Therefore, it is determined whether the surfaces including the second candidate node are the surfaces shown in FIGS. 9(b), 9(e), and 9(f). In a case where the surfaces including the second candidate node are the surfaces shown in FIGS. 9(b), 9(e), and 9(f) (step S47: YES), it is set as a residual candidate node. For example, in the virtual model displayed on the display device, the residual candidate node may be shown in red. In a case where the surfaces including the second candidate node are not the surfaces shown in FIGS. 9(b), 9(e), and 9(f) (step S47: NO), it is set as a non-target node.

Next, the number of residual candidate nodes is evaluated (step S4D). Specifically, it is determined whether the number of residual candidate nodes is equal to or less than a determination value (step S48). The determination value is, for example, any integer. For example, in a case where the existence of the residual candidate node is not permitted, the determination value may be set to zero. In a case where the result of the determination is that the number of residual candidate nodes is equal to or less than the determination value (step S48: YES), the attitude set in the virtual model is output as the quenching attitude (step S49a). Then, the process ends.

In a case where the result of the determination is that the number of residual candidate nodes is not equal to or less than the determination value (step S48: NO), the attitude set in the virtual model is changed to another attitude (step S49b). For example, in a case where the virtual axis of the virtual model is parallel to the x axis, attitude change information is output, in which the attitude of the virtual model rotated by a predetermined angle around the y axis so that the virtual axis is tilted with respect to the x axis is set as a post-change attitude (step S49b).

The first processing step S3 and the second processing step S4 described above are repeated until the number of residual candidate nodes becomes equal to or less than the determination value.

In short, in the quenching-attitude-setting method, the following conditions are used to determine that the vapor film 400 remains. Specifically, in a case where conditions 1, 2, and 3 are all satisfied, it can be determined that the vapor film 400 remains. Alternatively, in a case where conditions 1, 2, and 4 are all satisfied, it can also be determined that the vapor film 400 remains.

Condition 1: Equation (5) is satisfied.

Condition 2: Among the extreme values, the positive z direction from the point of the extreme value is not substantial.

Condition 3: Approximation to any of the surfaces shown in FIGS. 9(b), 9(e), and 9(f) is possible.

Condition 4: Equation (7), Equation (10), and Equation (11) are satisfied.

### [Quenching-Attitude-Setting Device]

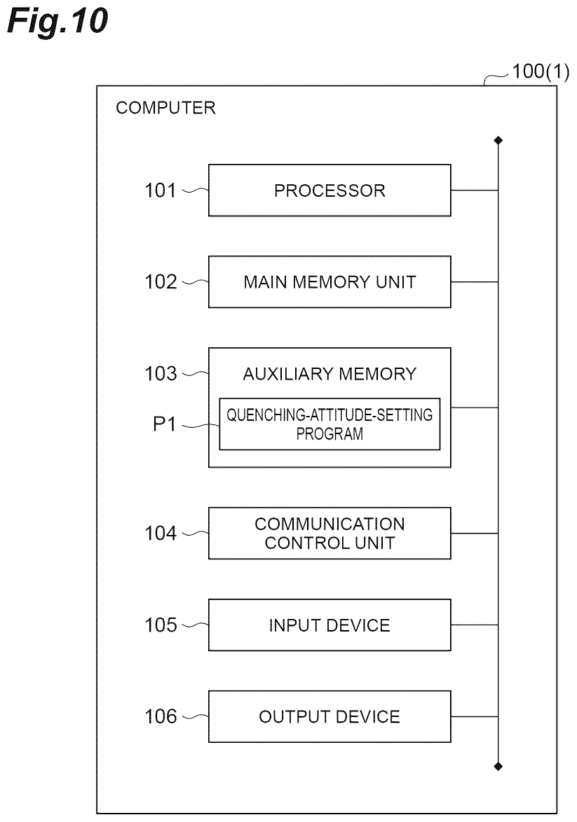

The hardware configuration of a quenching-attitude-setting device 1 will be described with reference to FIG. 10. FIG. 10 is a diagram illustrating an example of the hardware configuration of the quenching-attitude-setting device 1. The quenching-attitude-setting device 1 includes one or a plurality of computers 100. The computer 100 has a central processing unit (CPU) 101, a main memory unit 102, an auxiliary memory unit 103, a communication control unit 104, an input device 105, and an output device 106. The quenching-attitude-setting device 1 is constituted by one or a plurality of computers 100 constituted by the above hardware and software such as programs.

In a case where the quenching-attitude-setting device 1 is constituted by a plurality of computer 100, the plurality of computers 100 may be locally connected to each other. The plurality of computers 100 may be connected to each other through a communication network such as the Internet or an intranet. This connection logically constructs one quenching-attitude-setting device 1.

The CPU 101 (processor) executes an operating system, application programs, or the like. The main memory unit 102 is constituted by a read only memory (ROM) and a random access memory (RAM). The auxiliary memory unit 103 is a storage medium constituted by a hard disk, a flash memory, or the like. The auxiliary memory unit 103 generally stores a larger amount of data than the main memory unit 102. The communication control unit 104 is constituted by a network card or a wireless communication module. The input device 105 is constituted by a keyboard, a mouse, a touch panel, a microphone for voice input, or the like. The output device 106 is constituted by a display, a printer, or the like.

The auxiliary memory unit 103 stores in advance a quenching-attitude-setting program P1 and data necessary for processing. The quenching-attitude-setting program P1 causes the computer 100 to execute each functional element of the quenching-attitude-setting device. For example, the quenching-attitude-setting program P1 is read by the CPU 101 or the main memory unit 102. The quenching-attitude-setting program P1 operates at least one of the CPU 101, the main memory unit 102, the auxiliary memory unit 103, the communication control unit 104, the input device 105, and the output device 106. For example, the quenching-attitude-setting program P1 reads out and writes data in the main memory unit 102 and the auxiliary memory unit 103.

The quenching-attitude-setting program P1 may be provided in a form recorded on a tangible recording medium such as, for example, a CD-ROM, a DVD-ROM, or a semiconductor memory. The quenching-attitude-setting program P1 may be provided as a data signal through a communication network.

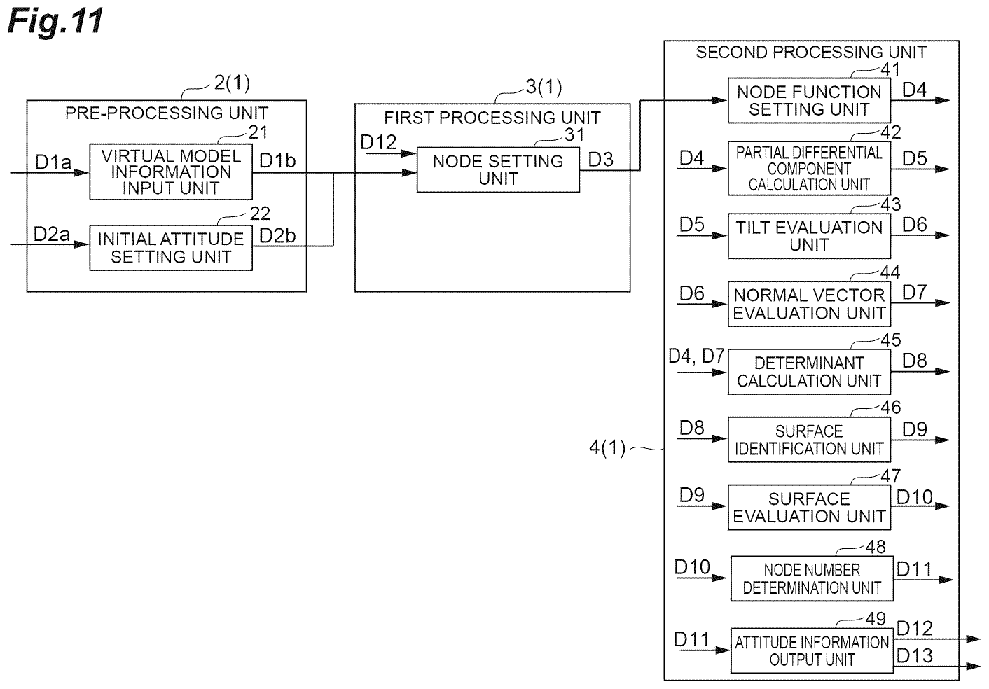

FIG. 11 is a functional block diagram of the quenching-attitude-setting device 1. The functional blocks shown in FIG. 11 are realized by executing the quenching-attitude-setting program P1 on the computer 100 shown in FIG. 10.

The quenching-attitude-setting device 1 includes a pre-processing unit 2, a first processing unit 3, and a second processing unit 4.

The pre-processing unit 2 executes the pre-processing step S2 of the quenching-attitude-setting method. The pre-processing unit 2 receives virtual model information D1a from the input device 105, the communication control unit 104, or the like. The pre-processing unit 2 passes virtual model information D1b and initial attitude information D2b to the first processing unit 3.

The pre-processing unit 2 includes a virtual model information input unit 21 and an initial attitude setting unit 22.

The virtual model information input unit 21 executes step S21. The virtual model information input unit 21 receives the virtual model information D1a from the input device 105 or the like. The virtual model information input unit 21 passes the virtual model information D1a to the first processing unit 3. The virtual model information input unit 21 may perform desired data processing on the virtual model information D1a. The virtual model information D1a received by the virtual model information input unit 21 and the virtual model information D1b passed by the virtual model information input unit 21 may coincide with each other, or may be different from each other.

The initial attitude setting unit 22 executes step S22. The initial attitude setting unit 22 receives initial attitude information D2a from the main memory unit 102 or the auxiliary memory unit 103. The initial attitude setting unit 22 passes the initial attitude information D2b to the first processing unit 3. The initial attitude information D2a received by the initial attitude setting unit 22 and the initial attitude information D2b passed by the initial attitude setting unit 22 coincide with each other.

### [First Processing Unit]

The first processing unit 3 executes the first processing step S3 of generating node information for extracting a residual candidate node. The first processing unit 3 receives the virtual model information D1b and the initial attitude information D2b from the pre-processing unit 2. The first processing unit 3 passes node information D3 to the second processing unit 4.

The first processing unit 3 includes a node setting unit 31. The node setting unit 31 executes step S31. The node setting unit 31 receives the virtual model information D1b and the initial attitude information D2b from the pre-processing unit 2. The node setting unit 31 generates the node information D3 using the virtual model information D1a and the initial attitude information D2b. The node setting unit 31 passes the node information D3 to the second processing unit 4.

The second processing unit 4 executes step S4C of identifying whether the type of node is a residual candidate node. The second processing unit 4 uses the number of residual candidate nodes to execute step S4D of determining whether the attitude of the virtual model used for evaluation can be adopted as the quenching attitude. The second processing unit 4 receives the node information D3 from the first processing unit 3. The second processing unit 4 generates quenching attitude information D13 or attitude change information D12 on the basis of the result of determining whether the attitude of the virtual model can be adopted using the node information D3. The second processing unit 4 passes the quenching attitude information D13 to the output device 106 or the like. The second processing unit 4 passes attitude change information D14 to the first processing unit 3.

The second processing unit 4 includes a node function setting unit 41, a partial differential component calculation unit 42, a tilt evaluation unit 43, a normal vector evaluation unit 44, a determinant calculation unit 45, a surface identification unit 46, a surface evaluation unit 47, a node number determination unit 48, and an attitude information output unit 49.

The node function setting unit 41 executes step S41. The node function setting unit 41 receives the node information D3 from the node setting unit 31. The node function setting unit 41 generates node function information D4 using the node information D3. The node function setting unit 41 passes the node function information D4 to the partial differential component calculation unit 42 and the determinant calculation unit 45.

The partial differential component calculation unit 42 executes step S42. The partial differential component calculation unit 42 receives the node function information D4 from the node function setting unit 41. The partial differential component calculation unit 42 generates partial differential component information D5 using the node function information D4. The partial differential component calculation unit 42 passes the partial differential component information D5 to the tilt evaluation unit 43.

The tilt evaluation unit 43 executes step S43. The tilt evaluation unit 43 receives the partial differential component information D5 from the partial differential component calculation unit 42. The tilt evaluation unit 43 generates first candidate node information D6 using the partial differential component information D5. The tilt evaluation unit 43 passes the first candidate node information D6 to the normal vector evaluation unit 44.

The normal vector evaluation unit 44 executes step S44. The normal vector evaluation unit 44 receives the first candidate node information D6 from the tilt evaluation unit 43. The normal vector evaluation unit 44 generates second candidate node information D7 using the first candidate node information D6. The normal vector evaluation unit 44 passes the second candidate node information D7 to the determinant calculation unit 45.

The determinant calculation unit 45 executes step S45. The determinant calculation unit 45 receives the second candidate node information D7 from the normal vector evaluation unit 44. The determinant calculation unit 45 receives the node function information D4 from the node function setting unit 41. The determinant calculation unit 45 generates determinant information D8 using the second candidate node information D7 and the node function information D4. The determinant calculation unit 45 passes the determinant information D8 to the surface identification unit 46.

The surface identification unit 46 executes step S46. The surface identification unit 46 receives the determinant information D8 from the determinant calculation unit 45. The surface identification unit 46 generates surface identification information D9 using the determinant information D8. The surface identification unit 46 passes the surface identification information D9 to the surface evaluation unit 47.

The surface evaluation unit 47 executes step S47. The surface evaluation unit 47 receives the surface identification information D9 from the surface identification unit 46. The surface evaluation unit 47 generates residual candidate node information D10 using the surface identification information D9. The surface evaluation unit 47 passes the residual candidate node information D10 to the node number determination unit 48.

The node number determination unit 48 executes step S48. The node number determination unit 48 receives the residual candidate node information D10. The node number determination unit 48 generates node number determination information D11 by determining whether the number of residual candidate nodes satisfies a condition using the residual candidate node information D10. The node number determination unit 48 passes the node number determination information D11 to the attitude information output unit 49.

The attitude information output unit 49 executes steps S49a and S49b. The attitude information output unit 49 receives the node number determination information D11. The attitude information output unit 49 selects either the attitude change information D12 or the quenching attitude information D13 using the node number determination information D11. In a case where the attitude change information D12 is selected, the attitude information output unit 49 passes the attitude change information D12 to the first processing unit 3. In a case where the quenching attitude information D13 is selected, the attitude information output unit 49 passes the quenching attitude information D13 to the output device 106.

### [Operational Effects]

The quenching-attitude-setting program P1 causes the computer 100 to execute the setting of the quenching attitude of the object 300 to be quenched including a disc-shaped portion provided with a through hole. The quenching-attitude-setting program P1 causes the computer 100 to execute a first process (step S3) of dividing a virtual model obtained by modeling the object 300 to be quenched into a plurality of elements based on the world coordinate system CS including a vertical direction as an axis, and a second process (step S4) of evaluating, for each of a plurality of elements, whether the vapor film 400 generated when the virtual model is immersed in the cooling oil 205 remains. The quenching-attitude-setting program P1 repeats the first process (step S3) and the second process (step S4) while changing the attitude of the virtual model with respect to the world coordinate system CS until the number of elements evaluated as having the vapor film 400 remaining satisfies a preset condition.

The quenching-attitude-setting method involves setting the quenching attitude of the object 300 to be quenched including a disc-shaped portion provided with a through hole. The quenching-attitude-setting method includes executing a first process (step S3) of dividing a virtual model obtained by modeling the object 300 to be quenched into a plurality of elements based on the world coordinate system CS including a vertical direction as an axis, and executing a second process (step S4) of evaluating, for each of a plurality of elements, whether the vapor film 400 generated when the virtual model is immersed in the cooling oil 205 remains. The quenching-attitude-setting method involves repeating the first process (step S3) and the second process (step S4) while changing the attitude of the virtual model with respect to the world coordinate system CS until the number of elements evaluated as having the vapor film 400 remaining satisfies a preset condition.

The quenching-attitude-setting device 1 sets the quenching attitude of the object 300 to be quenched including a disc-shaped portion provided with a through hole. The quenching-attitude-setting device 1 includes the first processing unit 3 configured to execute a first process (step S3) of dividing a virtual model obtained by modeling the object 300 to be quenched into a plurality of elements based on a world coordinate system CS including a vertical direction as an axis, and the second processing unit 4 configured to execute a second process (step S4) of evaluating whether the vapor film 400 generated when the virtual model is immersed in the cooling oil 205 remains for each of the plurality of elements. In the quenching-attitude-setting device 1, an operation of the first processing unit 3 and an operation of the second processing unit 4 are repeated while changing an attitude of the virtual model with respect to the coordinate system until the number of elements evaluated as having the vapor film 400 remaining satisfies a preset condition.

The quenching-attitude-setting program P1, the quenching-attitude-setting method, and the quenching-attitude-setting device 1 make it possible to obtain a plurality of elements (the node information D3) capable of being used to determine whether the vapor film 400 remains through the first process (step S3). Next, the second process (step S4) involves automatically determines whether the vapor film 400 remains for each element (the node information D3). By repeating the first process (step S3) and the second process (step S4) while changing the attitude of the virtual model with respect to the world coordinate system CS, it is possible to search for an attitude in which the number of elements where the vapor film 400 remains satisfies a desired condition. Therefore, the quenching-attitude-setting program P1, the quenching-attitude-setting method, and the quenching-attitude-setting device 1 make it possible to provide an attitude of the object 300 to be quenched capable of suppressing the influence of the vapor film 400 on the result of quenching.

The first process (step S3) includes dividing the virtual model into the elements each of which is a surface (step S31). The second process (step S4) includes obtaining a node function D4 of a quadratic form that approximates the elements (step S41). This first process can make it easy to obtain the attitude of the object 300 to be quenched capable of suppressing the influence of the vapor film 400 on the result of quenching.

The second process (step S4) includes evaluating the tilt of the element using the node function D4 (step S43). This second process can also make it easy to obtain the attitude of the object 300 to be quenched capable of suppressing the influence of the vapor film 400 on the result of quenching.

Evaluating the tilt of the element includes evaluating whether there are extreme values in the node function D4 (step S43) by partially differentiating the node function D4 (step S42). This process can make it easy to determine whether there is a possibility that the vapor film 400 will remain.

The second process (step S4) includes specifying either a main surface or a rear surface included in the element which is in contact with the cooling oil 205 (step S44). This second process can make it easy to determine elements on which the vapor film 400 does not remain.

The second process (step S4) includes identifying which of a plurality of quadratic surfaces prepared in advance the shape of the element corresponds to by using the node function D4 (step S46). This second process can also make it easy to determine whether there is a possibility that the vapor film 400 will remain.

Identifying which of the plurality of quadratic surfaces the shape corresponds to (step S4C) includes obtaining a decision determinant through second-order partial differentiation of the node function D4 (step S45), and evaluating which of defining equations (Equation (7) to Equation (11)) that define the plurality of quadratic surfaces the decision determinant (Equation (4)) corresponds to (step S46). This process can make it easy to identify the type of surface.

### Modification Example 1

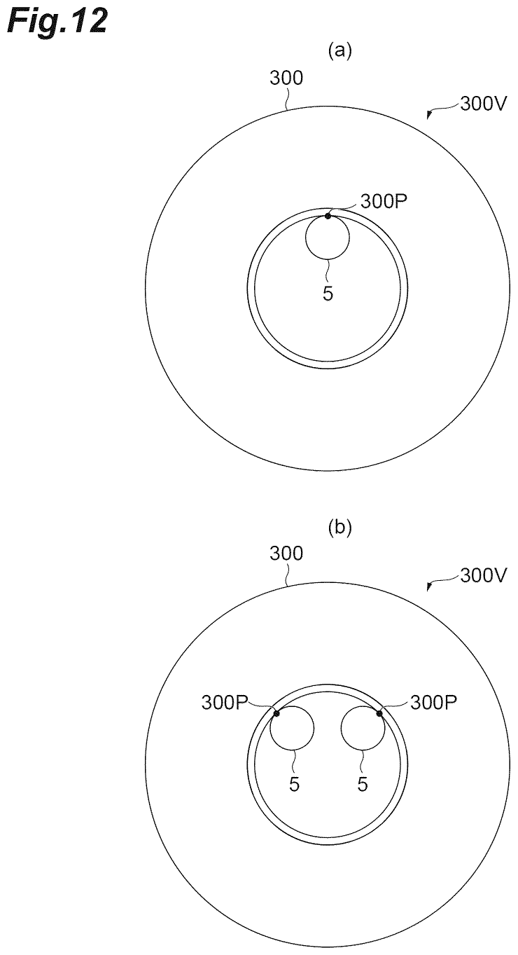

When the quenching attitude is derived, only the object 300 to be quenched was modeled. In actual quenching, the object 300 to be quenched is disposed in the quenching tool 5. The quenching tool 5 is in contact with the object 300 to be quenched. In that case, the vapor film 400 may remain at the contact portion between the object 300 to be quenched and the quenching tool 5. Consequently, as shown in FIGS. 12(a) and 12(b), a virtual model 300V may include the quenching tool 5 in addition to the object 300 to be quenched. The virtual model 300V in FIG. 12(a) includes one quenching tool 5. The virtual model 300V in FIG. 12(b) includes two quenching tools 5. In this case, when a contact portion 300P between the object 300 to be quenched and the quenching tool 5 is accurately modeled, it may not be possible to approximate the quadratic function shown in Equation (2). As a result, there may be cases in which partial differential calculation is impossible. Consequently, the location where partial differential calculation is impossible may be rounded (R-shaped) so that partial differential calculation is possible. According such modeling, it is possible to incorporate any type of quenching tool 5 into the virtual model and then execute the evaluation of a remaining vapor film.

Using the quenching-attitude-setting program P1, the quenching-attitude-setting method, and the quenching-attitude-setting device 1 described above, the attitudes of several virtual models 300A, 300B, 300C, and 300D was evaluated.

### Examination Example 1

In examination example 3, the attitude was evaluated using the virtual model 300A. The virtual model 300A corresponds to the object 300 to be quenched, and thus a detailed description thereof will be omitted.

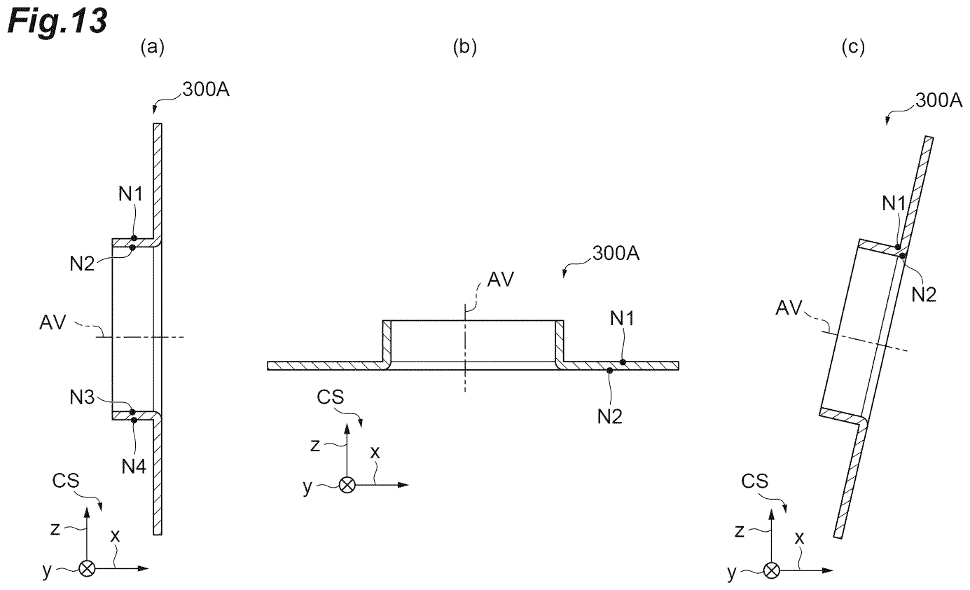

The virtual model 300A was set to be in the first attitude shown in FIG. 13(a). When the model was in the first attitude, nodes N1 to N4 satisfied Equation (5) which is Condition 1. Among the nodes N1 to N4, the nodes N1 and N3 did not satisfy “Condition 2: Among extreme values, the positive z direction from the point of the extreme value is not substantial,” and thus they were excluded from the target. The surface including the node N4 could be approximated by Equation (9) as a parabolic cylindrical surface which is convex downwardly. That is, it was found that the vapor film 400 does not remain on the surface including the node N4. The surface including the node N2 could be approximated by Equation (10) as a parabolic cylindrical surface which is convex upwardly. That is, it was found that the vapor film 400 remains on the surface including the node N2. Therefore, since it was found that there is the node N2 on which the vapor film 400 remains, it was found that the first attitude shown in FIG. 13(a) cannot be adopted as the quenching attitude of the virtual model 300A.

Further, it was also found that the results of examination example 1 are in good agreement with the phenomenon described using FIG. 3.

### Examination Example 2

The virtual model 300A was set to be in the second attitude shown in FIG. 13(b). When the model is in the second attitude, the nodes N1 and N2 satisfied Equation (5) which is Condition 1. Among the nodes N1 and N2, the node N1 did not satisfy “Condition 2: Among extreme values, the positive z direction from the point of the extreme value is not substantial,” and thus they were excluded from the target. The surface including the node N2 could be approximated by Equation (11) as a plane. That is, it was found that the vapor film 400 remains on the surface including the node N2. Therefore, since it was found that there is the node N2 on which the vapor film 400 remains, it was found that the second attitude shown in FIG. 13(b) cannot be adopted as the quenching attitude of the virtual model 300A.

Further, it was also found that the results of examination example 2 are in good agreement with the phenomenon described using FIG. 4.

### Examination Example 3

The virtual model 300A was set to be in the third attitude shown in FIG. 13(c). When the model is in the third attitude, the nodes N1 and N2 satisfied Equation (5) which is Condition 1. Among the nodes N1 and N2, the node N1 did not satisfy “Condition 2: Among extreme values, the positive z direction from the point of the extreme value is not substantial,” and thus they were excluded from the target. The surface including the node N2 could be approximated by Equation (7) as a hyperbolic paraboloid. Therefore, since it was found that there is no node on which the vapor film 400 remains, it was found that the attitude shown in FIG. 13(c) can be adopted as the quenching attitude of the virtual model 300A.

### Examination Example 4

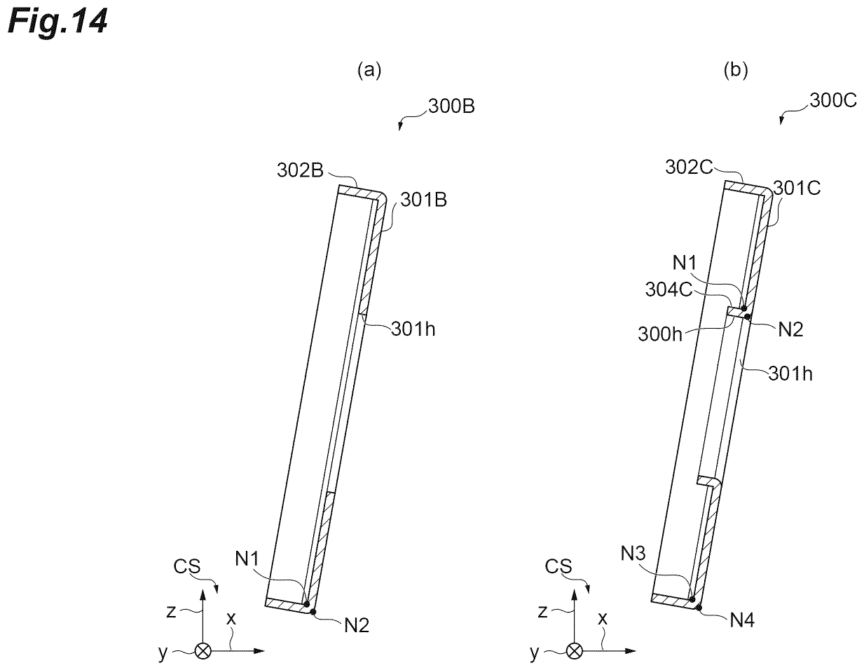

In examination example 4, the attitude was evaluated using a virtual model 300B shown in FIG. 14(a). The virtual model 300B includes a race 301B and a lip 302B. The race 301B has a race through hole 301h formed therein. The lip 302B stands up from the outer circumferential edge of the race 301B. The lip 302B extends linearly from the race 301B. The lip 302B does not include a bent portion between the portion connected to the race 301B and the tip.

The virtual model 300B was set to be in the attitude shown in FIG. 14(a). When the model is in this attitude, the nodes N1 and N2 satisfied Equation (5) which is Condition 1. Among the nodes N1 and N2, the node N1 did not satisfy “Condition 2: Among extreme values, the positive z direction from the point of the extreme value is not substantial,” and thus they were excluded from the target. The surface including the node N2 could be approximated by Equation (6) as an elliptical paraboloid which is convex downwardly. Therefore, it was found that there is no node at which the vapor film 400 can remain. As a result, it was found that the attitude shown in FIG. 14(a) can be adopted as the quenching attitude of the virtual model 300B.

### Examination Example 5

In examination example 5, the attitude was evaluated using a virtual model 300C shown in FIG. 14(b). The virtual model 300C has a race 301C, an inner lip 304C, and an outer lip 302C. The inner lip 304C forms an object through hole 300h together with a race through hole 301h provided in the race 301C. The outer lip 302C stands up from the outer circumferential edge of the race 301C. The direction in which the outer lip 302C stands up is the same as the direction in which the inner lip 304C stands up. The height of the outer lip 302C may be greater than that of the inner lip 304C.

The virtual model 300C was set to be in the attitude shown in FIG. 14(b). When the model is in this attitude, the nodes N1 to N4 satisfy Equation (5) which is Condition 1. Among the nodes N1 to N4, the nodes N1 and N3 do not satisfy “Condition 2: Among extreme values, the positive z direction from the point of the extreme value is not substantial,” and thus they were excluded from the target. The surface including the node N2 could be approximated by Equation (7) as a hyperbolic paraboloid. The surface including the node N4 could be approximated by Equation (6) as an elliptical paraboloid which is convex downwardly. Therefore, it was found that there is no node on which the vapor film 400 can remain. As a result, it was found that the attitude shown in FIG. 14(b) can be adopted as the quenching attitude of the virtual model 300C.

### Examination Example 6

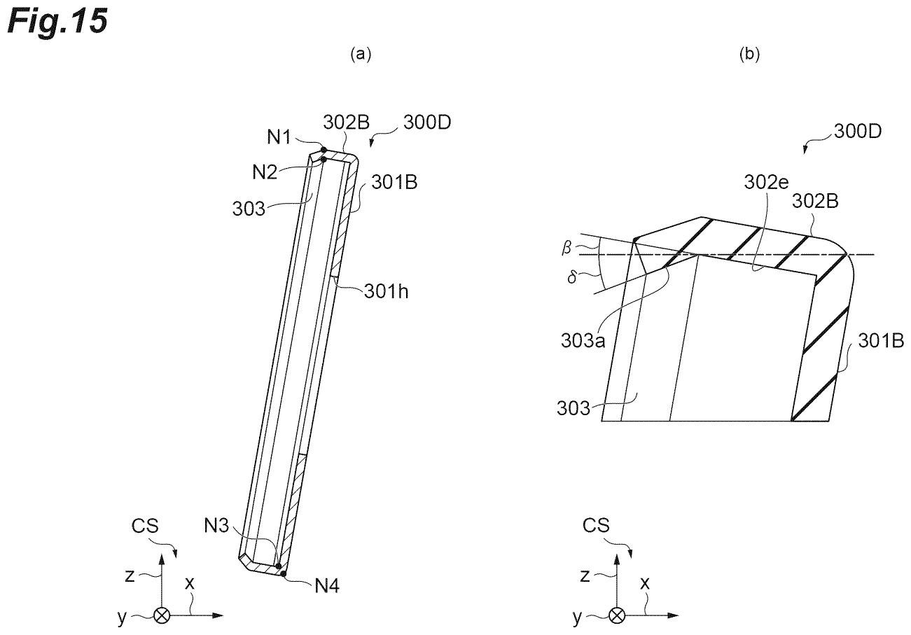

In examination example 6, the attitude was evaluated using a virtual model 300D shown in FIG. 15(a). The virtual model 300D includes a race 301D and a lip 302D. A race through hole 301h is formed in the race 301D. The lip 302D stands up from the outer circumferential edge of the race 301D. The lip 302D includes a curled portion 303 formed between the portion connected to the race 301D and the tip. The lip 302D is bent inward starting from the curled portion 303. The inner diameter of the tip portion of the lip 302D is smaller than the outer diameter of the race 301D.

As shown in FIG. 15(a), the virtual model 300D is set to be in the first attitude. As shown in FIG. 15(b), the first attitude can be defined as when the inner circumferential surface 302e of the virtual model 300D forms an angle β with respect to the horizontal axis (x axis or y axis). The first attitude can be defined as when the inner surface 303a of the curled portion 303 form an angle δ (δ>0) with respect to the horizontal axis. The condition δ>0 can also be said to be, in other words, a condition that α>0 is not satisfied.

When the model is in the first attitude, the nodes N1 to N4 satisfied Equation (5) which is Condition 1. Among the nodes N1 to N4, the nodes N1 and N3 do not satisfy “Condition 2: Among extreme values, the positive z direction from the point of the extreme value is not substantial,” and thus they were excluded from the target. The surface including the node N4 could be approximated as an elliptical paraboloid which is convex downwardly. However, the node N4 has no vapor film 400 remaining. On the other hand, the surface including the node N2 could be approximated as an elliptical paraboloid which is convex upwardly. Therefore, it could be determined that the vapor film 400 remains on the surface including the node N2. As a result, it was found that the first attitude shown in FIG. 15(a) cannot be adopted as the quenching attitude.

### Examination Example 7

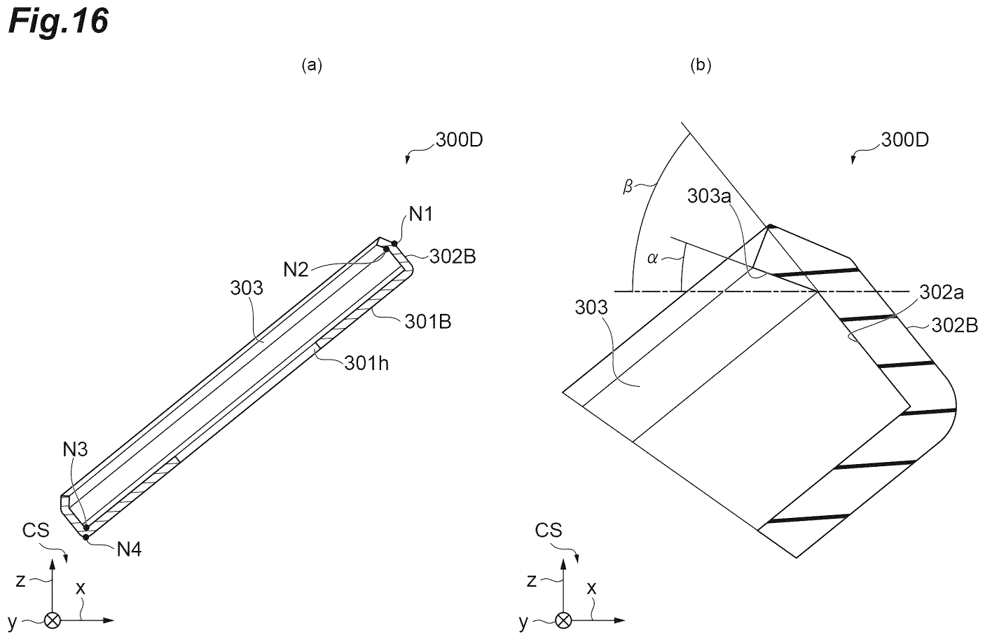

As shown in FIG. 16(a), in examination example 7, the virtual model 300D was set to be in the second attitude. The second attitude can be defined as when the inner circumferential surface 302e of the virtual model 300D forms an angle β with respect to the horizontal axis (x axis or y axis) as shown in FIG. 16(b). The second attitude can be defined as when the inner surface 303a of the curled portion 303 form an angle α (α>0) with respect to the horizontal axis.

When the model is in the second attitude, the nodes N1 and N2 satisfied Equation (5) which is Condition 1. It should be noted that in this case, the extreme value is reduced more than when 8>. Among the nodes N1 and N2, the node N1 does not satisfy “Condition 2: The positive z direction from the point of the extreme value is not substantial,” and thus they were excluded from the target. The node N2 could be approximated as an elliptical paraboloid which is convex downwardly. Therefore, it was found that there is no node at which the vapor film 400 can remain. As a result, it was found that the second attitude can be adopted as the quenching attitude of the virtual model 300D.

### REFERENCE SIGNS LIST

1 Quenching-attitude-setting device
5 Quenching tool
205 Cooling oil
300 Object to be quenched
300V Virtual model
400 Vapor film
CS World coordinate system
f Node function
S2 Pre-processing step
S3 First processing step
S4 Second processing step

1. A quenching-attitude-setting program for causing a computer to execute setting of a quenching attitude of an object to be quenched including a disc-shaped portion provided with a through hole, the program causing the computer to execute:
a first process of dividing a virtual model obtained by modeling the object to be quenched into a plurality of elements based on a coordinate system including a vertical direction as an axis; and
a second process of evaluating whether a vapor film generated when the virtual model is immersed in a cooling liquid remains for each of the plurality of elements,
wherein the first process and the second process are repeated while changing an attitude of the virtual model with respect to the coordinate system until the number of elements evaluated as having the vapor film remaining satisfies a preset condition.

2. The quenching-attitude-setting program according to claim 1, wherein the first process includes dividing the virtual model into the elements each of which is a surface, and
the second process includes obtaining a function of a quadratic form that approximates the elements.

3. The quenching-attitude-setting program according to claim 2, wherein the second process includes evaluating a tilt of the element using the function.

4. The quenching-attitude-setting program according to claim 3, wherein evaluating the tilt of the element includes evaluating whether there are extreme values in the function by partially differentiating the function.

5. The quenching-attitude-setting program according to claim 3, wherein the second process includes specifying either a main surface or a rear surface included in the element which is in contact with the cooling liquid.

6. The quenching-attitude-setting program according to claim 5, wherein the second process includes identifying which of a plurality of quadratic surfaces prepared in advance the shape of the element corresponds to by using the function.

7. The quenching-attitude-setting program according to claim 6, wherein identifying which of the plurality of quadratic surfaces the shape corresponds to includes
obtaining a decision determinant through second-order partial differentiation of the function, and
evaluating which of defining equations that define the plurality of quadratic surfaces the decision determinant corresponds to.

8. A quenching-attitude-setting method of setting a quenching attitude of an object to be quenched including a disc-shaped portion provided with a through hole, the method comprising:
executing a first process of dividing a virtual model obtained by modeling the object to be quenched into a plurality of elements based on a coordinate system including a vertical direction as an axis; and
executing a second process of evaluating whether a vapor film generated when the virtual model is immersed in a cooling liquid remains for each of the plurality of elements,
wherein the first process and the second process are repeated while changing an attitude of the virtual model with respect to the coordinate system until the number of elements evaluated as having the vapor film remaining satisfies a preset condition.

9. A quenching-attitude-setting device configured to set a quenching attitude of an object to be quenched including a disc-shaped portion provided with a through hole, the device comprising:
a first processing unit configured to execute a first process of dividing a virtual model obtained by modeling the object to be quenched into a plurality of elements based on a coordinate system including a vertical direction as an axis; and
a second processing unit configured to execute a second process of evaluating whether a vapor film generated when the virtual model is immersed in a cooling liquid remains for each of the plurality of elements,
wherein an operation of the first processing unit and an operation of the second processing unit are repeated while changing an attitude of the virtual model with respect to the coordinate system until the number of elements evaluated as having the vapor film remaining satisfies a preset condition.
